(19) United States
(12) Patent Application Publication
(10) Pub. No.: US 2006/0135176 A1
(43) Pub. Date: Jun. 22, 2006

(54) Method and controller for selecting between a plurality of different position determination approaches

(76) Inventor: Michelle Hao Xiong, Vernon Hills, IL (US)

Correspondence Address: MOTOROLA INC, 600 NORTH US HIGHWAY 45, ROOM AS437, LIBERTYVILLE, IL, 60048-5343, US

(21) Appl. No.: 11/022,479

(22) Filed: Dec. 22, 2004

(51) Int. Cl. H04Q 7/20

(52) U.S. Cl. 455/456.1

(57) ABSTRACT

A method and controller is provided for selecting between a plurality of different position determination approaches, where in at least some instances a selection is made between multiple mobile station based location determination approaches, as well as in other instances additional network based location determination approaches. In at least some instances, the selection between available mobile station based location determination approaches is based upon the availability and/or the receipt of assistance data from the network.

### FIELD OF THE INVENTION

The present invention relates generally to the determination of the position of a mobile station, and more particularly, to the selection of the position determination approach which is used to determine the mobile station's position.

### BACKGROUND OF THE INVENTION

Location determination is becoming an increasingly important capability for some electronic devices, such as cellular telephones, personal digital assistants (PDA's), and portable computers, as well as other devices. Separate from the direct benefits associated with knowing one's current location, many venders are introducing or contemplating location based services or solicitations, which can be selectively made available to the user of an electronic device, and which are dependent upon the device's current and/or anticipated location. Still other location based features and/or capabilities, relative to portable electronic devices, are being mandated by governmental agencies. One such example of a location based feature, which has been mandated by the US Federal Communication Commission (FCC), includes a feature known as E911.

In conjunction with supporting the various location based features and services, many different technologies and techniques have been developed, which are intended to support making a location determination, each having varying degrees of accuracy, time and supporting infrastructure requirements, and rates of success. For example, various technologies generally make use of terrestrial based reference locations, such as one or more base stations, non-terrestrial based reference locations, such as one or more orbiting satellites, or a combination of the two. Examples of various techniques and/or determination approaches include a mobile station-assisted assisted global positioning system, a mobile station-based assisted global positioning system, and an autonomous global positioning system.

A mobile station-assisted assisted global positioning system, also known as MS-assisted assisted GPS, generally provides for a location determination that is completed within the network infrastructure, often by a Position Determining Entity (PDE), based upon location measurement information which is received from the mobile station. Types of location measurement information that can be received from the mobile station include code phase and doppler measurement information from which the network infrastructure completes the location determination. In order to assist the mobile station in determining the code phase and doppler measurement information, the network infrastructure may initially provide the mobile station with time information, code phase and doppler estimates, which can often reduce the time necessary for the mobile station to determine the code phase and doppler measurement information. Some network operators (i.e. service providers) prefer a network based location determination approach, as it gives the network operators greater control over when and how the location determination is performed, as well as greater opportunities to manage the location results which are produced. Network based location determination approaches require that the network have computational capabilities within the network that are available for performing the location calculations.

Alternatively mobile station based approaches provides for more of the location calculation including the completion of location determination to be performed within the mobile station. Mobile station based location determination approaches include mobile station-based assisted global positioning systems, and autonomous global positioning systems.

A mobile station-based assisted global positioning system, also known as MS-based assisted GPS, generally provides for a location and/or position calculation, which occurs in the mobile station. However, in order to enable the location determination to be performed more quickly, and/or for the operation to better perform in weak signal environments, assistance data is often received from the network infiastructure. The assistance data can include time and date information, the mobile station's approximate location, and satellite ephemoris data and clock corrections. Once received from the network, different types of assistance data can be valid from a couple of minutes to a couple of hours or more. Consequently, if location determinations are to be performed more frequently, the MS-based assisted GPS approach may not necessarily supply assistance data in connection with each determination.

Alternatively, an autonomous global positioning system, does not generally receive any location determination information, such as assistance data, from the network. In at least some instances, the location determination information can come from the reference location sources directly, such as the GPS satellites. A location and/or position calculation, generally, is then similarly completed in the mobile station.

In many instances a device, which is capable of making a location determination, will support more than one location determination approach. As a result, devices that are capable of supporting more than one location determination approach will need to have some basis for selecting between the multiple different approaches, when a location determination needs to be made.

In some instances, the network or the application, which is the originator of the request that prompts the location determination, will provide instructions with the location request that will assist in at least partially selecting between the approaches, which might be available in a particular device. However, in some instances the instructions may be less than definitive, possibly resulting in some ambiguity as to which approach should be used. Where there is uncertainty concerning the particular approach to be used, there may be uncertainty concerning the interpretation of the location results. For example, it may not be clear the degree of accuracy, which might reasonably be anticipated and/or associated with the determined location.

At least one communication standard associated with the third generation partnership project (3GPP), namely technical specification 44.031, provides for a positioning instruction element including a field corresponding to method type, which allows a location determination request to identify or indicate a preference between MS-assisted and MS-based approaches. However, if an MS-based approached is identified or suggested, it is not clear whether an MS-based assisted GPS approach, an autonomous GPS approach, and/or possibly a still further approach should be used.

Consequently, a method for selecting between a plurality of different position determination approaches for locating a mobile station, which helps reduce the ambiguity relative to the particular approach that should be used would be beneficial.

### SUMMARY OF THE INVENTION

The present invention provides a method for selecting between a plurality of different position determination approaches for locating a mobile station. At least one aspect of the present invention involves when a mobile station based approach in a location determination request has been identified. The method includes determining whether assistance data from a network has been received by the mobile station. If assistance data has not been received, then a determination is made as to whether the mobile station supports an autonomous position determination approach. If an autonomous mode is supported then performing a location calculation using the autonomous position determination approach. If assistance data has been received or the mobile station does not support an autonomous position determination approach, then a location calculation is performed using a mobile based assisted position determination approach.

In at least one embodiment, prior to determining whether assistance data from a network has been received by the mobile station, if assistance data has not been received by the mobile station with the location determination request and the mobile station has not already requested assistance data, assistance data is requested from the network by the mobile station.

In at least a further embodiment, if assistance data has not been received and the mobile station does not support an autonomous position determination approach, then, when performing the location calculation using a mobile based assisted position determination approach, the mobile based assisted position determination approach is performed without the use of assistance data.

The present invention further provides a method for selecting between a plurality of different position determination approaches when a mobile station based approach has not specifically been identified in a location determination request.

The present invention still further provides a controller for selecting between a plurality of different position determination approaches for locating a mobile station, when a mobile station based approach in a location determination request is identified. The controller includes a processor for executing one or more sets of prestored instruction, and a storage circuit coupled to the processor. The storage circuit includes prestored instructions for determining whether assistance data from a network has been received by the mobile station. If assistance data has not been received, then a determination is made as to whether the mobile station supports an autonomous position determination approach. If an autonomous mode is supported, then a location calculation is performed using the autonomous position determination approach. If assistance data has been received, or the mobile station does not support an autonomous position determination approach, then a location calculation is performed using a mobile based assisted position determination approach.

In at least one embodiment, the controller is adapted for use in a mobile station, where in at least one aspect of the present invention, the mobile station additionally includes an antenna and a transceiver, and the storage circuit additionally includes prestored instructions for one or more location determination approaches.

These and other features, and advantages of this invention are evident from the following description of one or more preferred embodiments of this invention, with reference to the accompanying drawings.

### BRIEF DESCRIPTION OF THE DRAWINGS

FIG. 1 is a block diagram of an exemplary communication network;

FIG. 2 is a block diagram of a mobile station incorporating a controller for selecting between a plurality of different position determination approaches for locating a mobile station, in accordance with at least one embodiment of the present invention;

FIG. 3 is a flow diagram of a method for selecting between a plurality of different position determination approaches for locating a mobile station, in accordance with at least one embodiment of the present invention.

FIG. 4 is a flow diagram of a method with which the method of FIG. 3 can be used, for example when it has not already been determined or identified that a mobile station based approach in connection with a location determination request should be used.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

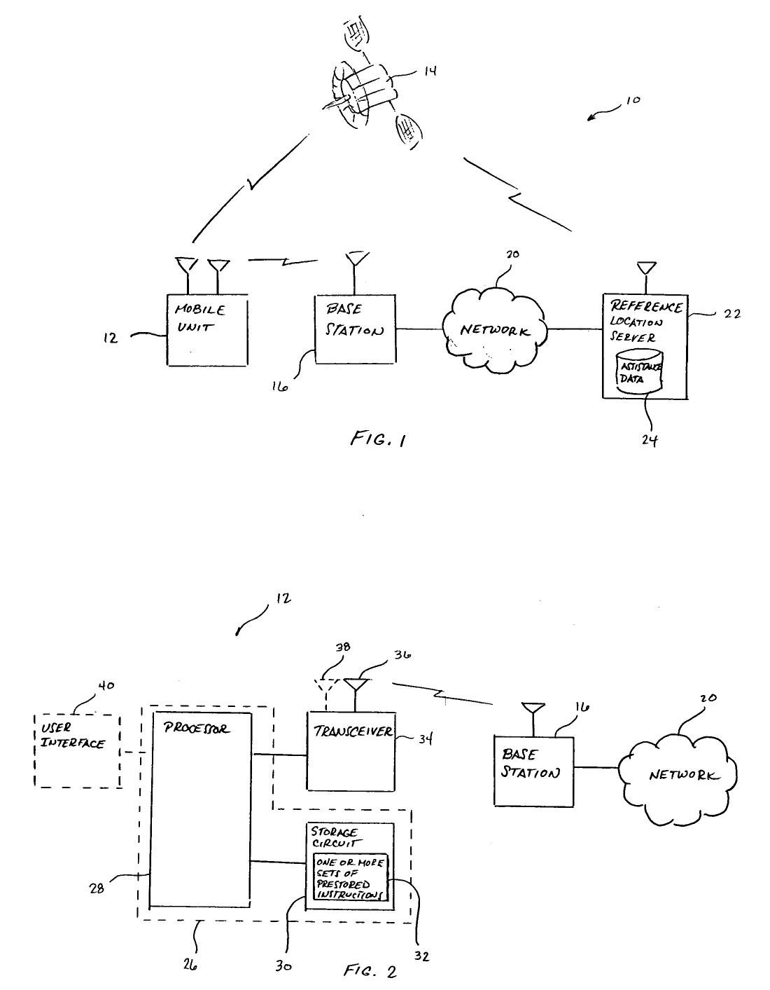

FIG. 1 illustrates a block diagram of an exemplary communication network 10 including a mobile station 12, which generally can communicate within the network 10. The mobile station 12 can be any suitable device, which is capable of movement relative to one or more reference locations. In the illustrated embodiment, at least one example of a reference location includes a satellite 14, where in at least some instances the satellite 14 represents one of a plurality of satellites, which are sometimes referred to as a constellation. However in some embodiments, a base station 16 may additionally or alternatively function as a reference location, where similar to the satellite 14 the base station 16 can represent one of a plurality of base stations. Generally, the satellites, base stations, etc., which function as reference locations, can be used with the mobile station to determine the location of the mobile station 12, which often includes some ability to transmit and/or receive signals communicated between the mobile station 12 and the reference location(s).

In at least some embodiments, the mobile station 12 can be a radio telephone, such as a cellular telephone, which can wirelessly communicate with a network 20 via the base station 16, or other type of wireless transceiver, which is communicatively coupled to the network 20. However one skilled in the art will appreciate that the mobile station 12 could alternatively be representive of other types of devices, such as a personal digital assistant (PDA), a cordless telephone, a portable computer, or a dedicated global positioning system (GPS) terminal, which may have a global positioning system receiver or transceiver incorporated therein. Furthermore, the mobile station 12 could be a hand-held device, or a device mounted in or on a vehicle, such as an automobile.

The network 20 may include any type of network that is capable of sending and receiving communication signals. In at least one embodiment, the network 14 includes a wireless communication network. The network 20 may also include or be in communication with a data network, such as the Internet, an Intranet, a local area network (LAN), a wide area network (WAN), a cable network, and other like communication systems. The network 20 may also include or be in communication with a telecommunications network, such as a local telephone network, long distance telephone network, cellular telephone network, satellite communications network, cable television network and other like communications systems. Furthermore, the network 20 may include or be in communication with more than one network and may include a plurality of different types of networks. Thus, the network 20 may include or be in communication with a plurality of data networks, a plurality of telecommunications networks, or a combination of data and telecommunications networks and other like communication systems.

In addition to infrastructure which supports communication within a network, the network 20 will often include and link together other devices, such as other mobile and non-mobile stations, where some of the devices might function as interfaces for one or more users for sending and receiving information via the network 20. Other devices, such as some servers, may supply user accessible content, which is of direct interest to the user. In other instances, some servers may supply information, which is useful in managing the operation of the network.

In at least one embodiment of the present invention a reference location server 22 is coupled to the network 20, which can store or supply data from a data structure 24 containing assistance data, such as data relative to the reference locations that can be used in a location determination of a mobile station. In some instances, the reference location server can be incorporated within a position determining entity, and may similarly include a global positioning system receiver/transceiver for separately communicating with one or more of the corresponding reference locations.

While the base station 16 and reference location server 22 are illustrated separate from the network 20, in many instances the base station 16 and the reference location server 22 are understood to be part of the network 20 and/or the network infrastructure.

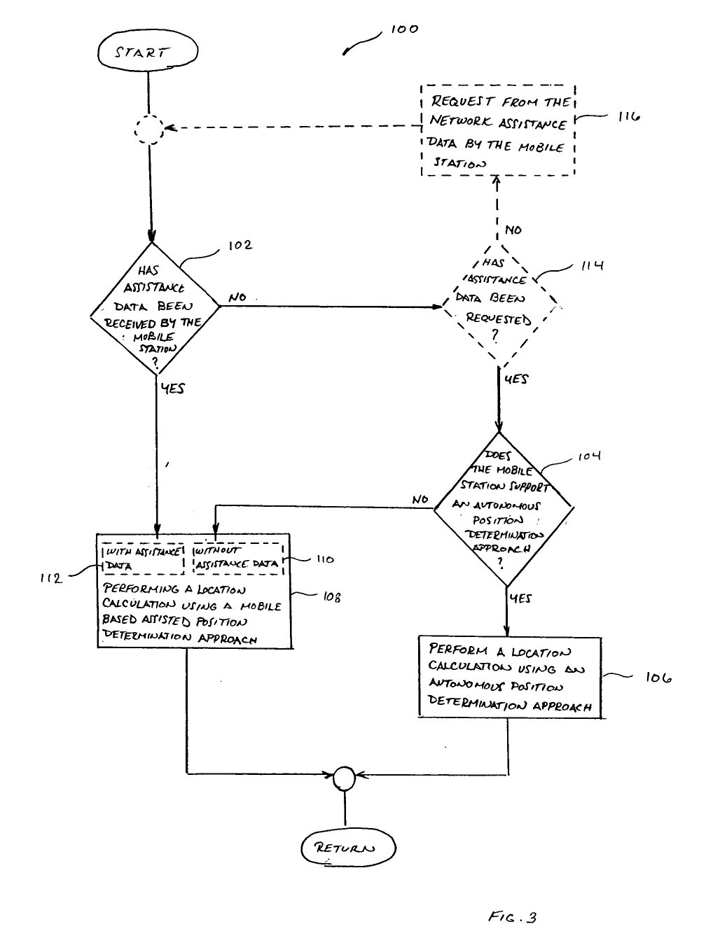

A block diagram of an exemplary mobile station 12 incorporating a controller 26 for selecting between a plurality of different position determination approaches for locating a mobile station 12, in accordance with at least one embodiment of the present invention, is illustrated in FIG. 2. In the illustrated embodiment, the controller includes a processor 28 and a storage unit 30. The storage unit 30 includes one or more sets of prestored instructions 32, which can be executed by the processor 28. The processor 28 can include and/or take the form of a microprocessor. The storage circuit 30 can include both volatile and non-volatile forms of memory, many types of which are well known. At least one example includes semiconductor memory circuits, such as random access memory (RAM), read only memory (ROM), and/or electronically programmable read only memory (EPROM), which may be separate from or integrated as part of a microprocessor forming all or part of the processor 28. One skilled in the art will recognize that other forms of memory circuits may similarly be suitable. Other examples of storage units 30 can include a fixed drive or hard drive, which commonly stores information magnetically. However any form of storage unit 30 may be suitable, as long as it supports the ability to store and retrieve the information, which is stored therein.

Additionally coupled to processor 28 is a transceiver 34, which can facilitate communication with the network 20, for example via the base station 16, and/or facilitate communication with the one or more reference locations, such as satellite 14 and in some instances the base station 16. In the illustrated embodiment, the transceiver 34 is coupled to at least a first antenna 36 for wirelessly communicating with the base station 16. The same antenna 36, or a further second antenna 38 may be coupled to the transceiver 34 potentially for facilitating communication with satellite 14 (FIG. 1). Furthermore, the mobile station 12 may include additional and/or dedicated transceivers. Still further, in some embodiments, a user interface 40 may be similarly coupled to the processor 26. Examples of elements, which can form all or parts of the user interface, include user actuatable keys, displays, speakers, and microphones, as well as other elements which facilitate interaction between the device and the user. In some instances the display may be touch sensitive.

In the illustrated embodiment, the execution of at least some of the one or more sets of prestored instructions included with the storage circuit 30 by the processor 28, enables the mobile unit 12 to select between a plurality of different position determination approaches. A position determination, relative to the mobile station, can potentially be initiated in one or more of several different ways. At least a couple of examples include a mobile terminated location request (MTLR), a network initiated location request (NILR), and a mobile originated location request (MOLR).

A network initiated location request involves a location request of a mobile station that is initiated by the network, and can often occur in an emergency situation, where in addition to determining the identity of a caller, an emergency call will also trigger an attempt to determine where the caller is located, in order to assist any emergency assistance operation. A mobile originated location request, typically is associated with a location request made by the mobile station user for determining their current location for use by the mobile, which can sometimes be associated with an application being executed on the mobile station, or for purposes of communicating their current location to a third party. A mobile terminated location request, will generally involve a request from a mobile user for information involving the location of a different user. Generally before a mobile user will have access to location information of another mobile user, authorization for access to such information will need to be verified. Regardless as to how the location request is initiated, in the context of at least one cellular environment conforming to the 3GPP standard, a location request will generally result in a measure position request being conveyed as part of a radio resource location services protocol (RRLP).

As noted previously, in instances where a mobile station is capable of multiple different approaches for locating a mobile station, it may not be clear from the measure position request, which approach should be and/or will be used. Present provisions within the 3GPP standard provide a method type field, which can either identify or indicate a preference between a mobile station assisted location determination approach and a mobile station based location determination approach. However, in some instances multiple mobile station based location determination approaches may exist, so the present definitions may be inadequate for clearly identifying, which mobile station based location determination approach should be used.

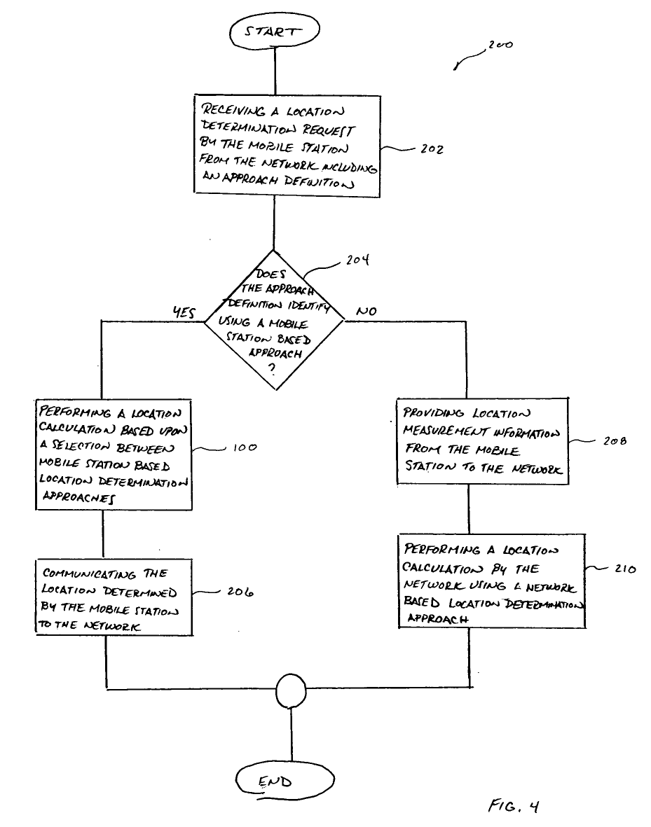

FIG. 3 illustrates a flow diagram of a method for selecting between a plurality of different position determination approaches for locating a mobile station, in accordance with at least one embodiment of the present invention, when a mobile station based approach in a location determination request is identified. The method includes making a determination 102 as to whether assistance data has been received by the mobile station. In at least one embodiment of the present invention, an indication as to whether assistance data been received may be based upon the value of a corresponding flag in the processor 28 and/or the identification of the presence of the data in the storage circuit 30. Because assistance data can often become stale, a validity period countdown timer for the assistance data may be maintained. Alternatively, a time stamp associated with the receipt of the assistance data can be maintained, and/or an expiration time associated with the validity period of the assistance data could be maintained. In either instance, a timer reflective of the current time could be compared against one or both of the stored time values for determining whether assistance data, which is current and/or still valid, has been received.

If assistance data, which is current and/or still valid, has not been received, then a determination 104 is made as to whether the mobile station supports an autonomous position determination approach. If an autonomous position determination approach is supported, then a location calculation is performed 106 using an autonomous position determination approach. Alternatively, if an autonomous position determination approach is not supported, then a location calculation is performed 108 using a mobile based assisted position determination approach, even if assistance data is unavailable 110. If assistance data, which is current and/or still valid, has been received, then a location calculation using a mobile based assisted position determination approach is performed 108, generally with the use of at least some of the available assistance data 112.

In some embodiments and/or instances, before a determination is made as to whether the mobile station supports an autonomous position determination approach, after initially making a determination that assistance data has not been received, a mobile station may attempt to determine 114 if assistance data has been requested. Similar to determining whether assistance data has been received, various techniques can be used to record and identify if assistance data has been requested, such as a corresponding flag. If assistance data has not recently or not yet been requested, the mobile station will request 116 assistance data from the network. After assistance data has been requested by the mobile station from the network, and a predetermined period of time has elapsed, the mobile station will generally reevaluate whether assistance data has been received 102, and correspondingly proceed as noted above, in response to whether assistance data, which is current and/or still valid, has been received or not.

In at least some instances, the method illustrated in FIG. 3 can be used in instances where it is not yet known whether a mobile station based approach or a mobile station assisted approach has been defined and/or has been identified as being preferred. An example of such an instance is illustrated in FIG. 4, which provides a still further method for selecting between a plurality of different position determination approaches for locating a mobile station. In these instances, a method 200 may additionally include the mobile station initially receiving 202 a location determination request from the network including an approach definition, which may correspond to a method type field of a radio resource location services protocol measure position request.

A determination 204 is then made as to whether the approach definition identifies using a mobile station based approach. If the approach definition identifies using a mobile station based approach, then a location calculation is performed based upon a selection between mobile station based location determination approaches, which in at least some instances may be consistent with the method 100 described in connection with FIG. 3. The determined location is then communicated 206 to the network in response to the location determination request.

If the approach definition does not identify using a mobile station based approach, then the mobile station provides 208 measurement information to the network, such as the code phase and doppler measurement information. A location calculation is then performed 210 by location determining resources available within the network, such as a position determination entity (PDE), using a network based location determination approach. An example of a network based determination approach includes a mobile station assisted determination approach.

While in connection with the embodiment illustrated in FIG. 2, the method has been illustrated as being implemented using one or more sets of prestored instruction 32, which are executed within a processor 28, one skilled in the art will readily appreciate that the controller 26 for selecting between a plurality of different position determination approaches can alternatively and/or partially be implemented in hardware using discrete or integrated circuit elements, including logic gates and/or sequential state machines. Furthermore, to the extent that prestored instructions may be used, the prestored instruction can take the form of software instructions and/or microcode, which can be executed within a processor. One skilled in the art will readily appreciate that still further approaches are possible without departing from the teachings of the present invention.

While the preferred embodiments of the invention have been illustrated and described, it is to be understood that the invention is not so limited. Numerous modifications, changes, variations, substitutions and equivalents will occur to those skilled in the art without departing from the spirit and scope of the-present invention as defined by the appended claims.

What is claimed is:

1. A method for selecting between a plurality of different position determination approaches for locating a mobile station, when a mobile station based approach in a location determination request is identified, said method comprising:
determining whether assistance data from a network has been received by the mobile station;
if assistance data has not been received, then determining whether the mobile station supports an autonomous position determination approach, and if autonomous mode is supported then performing a location calculation using the autonomous position determination approach;
if one or more of 1) assistance data has been received, and 2) the mobile station does not support an autonomous position determination approach, then performing a location calculation using a mobile based assisted position determination approach.

2. A method in accordance with claim 1 wherein prior to determining whether assistance data from a network has been received by the mobile station, if assistance data has not been received by the mobile station with the location determination request, requesting by the mobile station assistance data from the network.

3. A method in accordance with claim 1 wherein prior to determining whether assistance data from a network has been received by the mobile station, if assistance data has not been received by the mobile station with the location determination request and the mobile station has not already requested assistance data, requesting by the mobile station assistance data from the network.

4. A method in accordance with claim 1 wherein if assistance data has not been received and the mobile station does not support an autonomous position determination approach, then, when performing the location calculation using a mobile based assisted position determination approach, the mobile based assisted position determination approach is performed without the use of assistance data.

5. A method in accordance with claim 1, wherein after a location calculation is performed, the mobile station communicates the results of the location calculation to the network.

6. A method in accordance with claim 1, wherein after a location calculation is performed, the mobile station uses the location calculation in an application being executed in the mobile station.

7. A method in accordance with claim 1, wherein the mobile station is a radiotelephone.

8. A method for selecting between a plurality of different position determination approaches for locating a mobile station, said method comprising:
receiving a location determination request by the mobile station from a network, which includes an approach definition;
if the approach definition includes an indication to use a mobile station based approach, determining if assistance data has been received by the mobile station from the network;
if assistance data has not been received, then determining whether the mobile station supports an autonomous position determination approach, and if autonomous mode is supported then performing a location calculation using the autonomous position determination approach;
if one or more of 1) assistance data has been received, and 2) the mobile station does not support an autonomous position determination approach, then performing a location calculation using a mobile based assisted position determination approach; and
communicating the location determined by the mobile station to the network; and
if the approach definition includes an indication to use a mobile station assisted approach, then providing location measurement information from the mobile station to the network, and performing a location calculation by the network using a mobile station assisted determination approach.

9. A method in accordance with claim 8 wherein prior to determining whether assistance data from a network has been received by the mobile station, if assistance data has not been received by the mobile station with the location determination request, requesting by the mobile station assistance data from the network.

10. A method in accordance with claim 8 wherein prior to determining whether assistance data from a network has been received by the mobile station, if assistance data has not been received by the mobile station with the location determination request and the mobile station has not already requested assistance data, requesting by the mobile station assistance data from the network.

11. A method in accordance with claim 8 wherein if assistance data has not been received and the mobile station does not support an autonomous position determination approach, then, when performing the location calculation using a mobile based assisted position determination approach, the mobile based assisted position determination approach is performed without the use of assistance data.

12. A controller for selecting between a plurality of different position determination approaches for locating a mobile station, when a mobile station based approach in a location determination request is identified, said controller comprising:
a processor for executing one or more sets of prestored instruction; and
a storage circuit coupled to the processor, said storage circuit including
prestored instructions for determining whether assistance data from a network has been received by the mobile station;
if assistance data has not been received, then determining whether the mobile station supports an autonomous position determination approach, and if autonomous mode is supported then performing a location calculation using the autonomous position determination approach;
if one or more of 1) assistance data has been received, and 2) the mobile station does not support an autonomous position determination approach, then performing a location calculation using a mobile based assisted position determination approach.

13. A controller in accordance with claim 12 wherein said controller is adapted for use in a mobile station.

14. A mobile station comprising:
an antenna;
a transceiver coupled to the antenna adapted for wirelessly communicating with a network;
a processor for executing one or more sets of prestored instruction; and
a storage circuit coupled to the processor, said storage circuit including
prestored intruction for receiving a location determination request,
a plurality of sets of prestored instructions for performing a location calculation including one or more of prestored instructions for an autonomous position determination approach, prestored instructions for a mobile based assisted position determination approach, and prestored instructions for a mobile station assisted determination approach,
prestored instructions selecting between a plurality of different position determination approaches including prestored instructions for determining whether assistance data from a network has been received by the mobile station,
if assistance data has not been received, then determining whether the mobile station supports an autonomous position determination approach, and if autonomous mode is supported then performing a location calculation using the autonomous position determination approach,
if one or more of 1) assistance data has been received, and 2) the mobile station does not support an autonomous position determination approach, then performing a location calculation using a mobile based assisted position determination approach, and prestored instructions for communicating the location determined by
the mobile station to the network.

15. A mobile station in accordance with claim 14 wherein the antenna is adapted for communicating with one or more terrestrial based cellular base stations.

16. A mobile station in accordance with claim 15 further comprising a second antenna adapted for communicating with one or more space based satellites.

17. A mobile station in accordance with claim 14 wherein the mobile station is a radiotelephone.

18. A mobile station in accordance with claim 14 wherein the mobile station is a global position location system.
